(19) United States
(12) Patent Application Publication
(10) Pub. No.: US 2018/0270180 A1
(43) Pub. Date: Sep. 20, 2018

(54) METHOD AND DEVICE FOR DISPLAYING NOTIFICATION MESSAGE AND MOBILE TERMINAL

(71) Applicant: BEIJING KINGSOFT INTERNET SECURITY SOFTWARE CO., LTD., Beijing (CN)

(72) Inventor: Siwei Chen, Beijing (CN)

(73) Assignee: BEIJING KINGSOFT INTERNET SECURITY SOFTWARE CO., LTD., Beijing (CN)

(21) Appl. No.: 15/975,078

(22) Filed: May 9, 2018

Related U.S. Application Data
(63) Continuation of application No. PCT/CN2016/083477, filed on May 26, 2016.

(30) Foreign Application Priority Data
Nov. 11, 2015 (CN) 201510768032.0

(51) Int. Cl. H04L 12/58; G06F 17/27

(52) U.S. Cl. CPC H04L 51/24; H04M 1/0202; G06F 17/2765

(57) ABSTRACT

A device and mobile terminal for display a notification message implement a method which includes: acquiring a notification message in a notification bar; analyzing the notification message according to a pre-set analyzing rule to obtain a message content and a contact; integrating the message content based on the contact; and displaying an integrated message content in a screen locked interface.

### CROSS-REFERENCE TO RELATED APPLICATION

This application is a continuation of International Application PCT/CN2016/083477, with an international filing date of May 26, 2016, which claims a priority to and benefits of Chinese Patent Application Serial No. 201510768032.0, filed with the State Intellectual Property Office of P. R. China on Nov. 11, 2015, the entire content of which is incorporated herein by reference.

### FIELD

The present disclosure relates to the field of mobile terminal technology, and more particularly to a method and device for displaying a notification message and a mobile terminal.

### BACKGROUND

Usually, at the top of a screen of a smartphone, there is a notification bar to display a notification message to a user in a form of a small icon. The smartphone allows the system or a third party application to push the notification message to the notification bar. The user can pull down the notification bar to view a detailed content of the notification message pushed.

With the continuous development and explosive growth of applications for the mobile phone, more and more applications are installed in the mobile phone. Those applications often push the notification message to the notification bar for different business purposes, resulting that the number of messages received by a mobile terminal are increasing, and thus a message reminder in the notification bar has been unable to meet the needs of users. In order to facilitate the user to check the messages received, the messages in the notification bar can be displayed in a screen locked interface with a screen locked application.

However, it is inconvenient to check for uses if each message will pop up as received, and the messages will be stacked in the screen locked interface when several messages are received.

### SUMMARY

The present disclosure provides a method and device for displaying a notification message and a mobile terminal.

In embodiments of a first aspect of the present disclosure, a method for displaying a notification message is provided, which includes: acquiring a notification message in a notification bar; analyzing the notification message according to a pre-set analyzing rule to obtain a message content and a contact; integrating the message content based on the contact; and displaying an integrated message content in a screen locked interface.

In embodiments of a second aspect of the present disclosure, a mobile terminal is provided, which includes: a shell; a circuit board disposed in a space defined by the shell; a memory, disposed on the circuit board and configured to store an executable program code; a processer, disposed on the circuit board and configured to read the executable program code stored in the memory to execute a program corresponding to the executable program code; and a power circuit, configured to supply power to each component or circuit of the mobile terminal, wherein the processer is further configured to: acquire a notification message in a notification bar; analyze the notification message according to a pre-set analyzing rule to obtain a message content and a contact; integrate the message content based on the contact; and display an integrated message content in a screen locked interface.

In embodiments of a third aspect of the present disclosure, a computer-readable storage medium is provided, having stored therein instructions that, when executed by a processor of a terminal, causes the terminal to perform a method for displaying a notification message as described above.

### BRIEF DESCRIPTION OF THE DRAWINGS

FIG. 1 is a flow chart of a method for displaying a notification message according to an embodiment of the present disclosure;

FIG. 2 is a schematic diagram showing notification messages displayed in a screen locked interface;

FIG. 3 is a flow chart of a method for displaying a notification message according to another embodiment of the present disclosure;

FIG. 4 is a schematic diagram showing notification messages from wechat in a notification bar;

FIG. 5 is a schematic diagram showing messages from wechat displayed in a screen locked interface;

FIG. 6 is a flow chart of a method for displaying a notification message according to yet another embodiment of the present disclosure;

FIG. 7 is a schematic diagram showing notification messages from a short message service application in a notification bar;

FIG. 8 is a schematic diagram showing messages from a short message service application displayed in a screen locked interface;

FIG. 9 is a block diagram of a device for displaying a notification message according to an embodiment of the present disclosure.

### DETAILED DESCRIPTION

Embodiments of the present disclosure will be described in detail in the following, and examples of these embodiments are shown in the drawings. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

In the following, a method and device for displaying a notification message and a mobile terminal according to embodiments of the present disclosure will be described in detail with reference to the drawings.

FIG. 1 is a flow chart of a method for displaying a notification message according to an embodiment of the present disclosure.

As shown in FIG. 1, the method includes as follows.

S101, a notification message in a notification bar is acquired.

Specifically, when a mobile terminal is in a screen locked state, it is possible to monitor a notification bar management interface of an operating system of the mobile terminal and acquire from the notification bar management interface a notification message received by the notification bar when it is monitored that the notification bar management interface receives the notification message sent by an application.

The application may be an instant messaging (IM) application or a short message service (SMS) application. For example, the application may be the IM application, such as whatsapp, facebook messenger, wechat and the like.

For example, if the mobile terminal is a smartphone based on an android system, it is possible to monitor a Notification Listener Service interface of the smartphone and acquire from the Notification Listener Service interface a notification message sent by an application when the smartphone receives the notification message sent by the application. It should be noted that, the Notification Listener Service is such a service that is activated by the android system, and the android system will send an action and information of a notification back to the Notification Listener Service when an application launches the notification.

S102, the notification message is analyzed according to a pre-set analyzing rule to obtain a message content and a contact.

Specifically, it is possible to determine the application corresponding to the notification message, acquire identification information of the application, and acquire the analyzing rule corresponding to the notification message according to the identification information of the application, after the notification message in the notification bar is acquired.

Specifically, after the identification information of the application is acquired, it is possible to acquire the analyzing rule corresponding to the notification message according to the identification information of the application and a pre-stored correspondence between the application and the analyzing rule of the notification message.

Further, it is possible to analyze the notification message according to the analyzing rule after determining the analyzing rule corresponding to the notification message.

It should be noted that, the analyzing rules corresponding to notification messages sent by different applications are different.

If a current notification message in the notification bar is a notification message sent by an IM application, it is possible to analyze a title of the notification message first to obtain a first contact in the title, then analyze a content of the notification message to obtain first separation identification information in the content of the notification message, take a content at a left side of the first separation identification information as a second contact and take a content at a right side of the first separation identification information as a first message content; and judge whether the first contact is the same as the second contact, if yes, determine the notification message to be a private message, and take the first contact as the contact of the notification message and the first message content as the message content of the notification message.

In an embodiment of the present disclosure, if the first contact is not the same as the second contact, it is determined that the notification message is a group message, the first contact is taken as the contact of the notification message, and the second contact and the first message content are taken as the message content of the notification message. Specifically, contents in a content view of the notification bar can be directly as the message content of the notification message.

In an embodiment of the present disclosure, if the notification message in the notification bar is a notification message sent by a SMS application, it is possible, after the analyzing rule of the notification message is determined, to analyze a content of the notification message to obtain second separation identification information in the content of the notification message, then to take a content at a left side of the second separation identification information as the contact of the notification message and to take a content at a right side of the second separation identification information as the message content of the notification message.

In an embodiment of the present disclosure, the first separation identification information and the second separation identification information each are a character string.

For example, if the notification message is sent by wechat, the corresponding first separation identification information may be “:” (i.e., colon+space). Besides, if the notification message is sent by SMS, the corresponding second separation identification information may be “:”, that is, during the analyzing process, a colon is taken as a separator, a content at a left side of the colon is taken as the contact of the notification message, and a content at a right side of the colon is taken as the message content of the notification message.

S103, the message content is integrated based on the contact and an integrated message content is displayed in a screen locked interface.

Specifically, after the message contents and the contacts of the notification message are analyzed, it is possible to establish a correspondence between the message content and the contact and integrate the message contents corresponding to a same contact in the correspondence.

After the message content is integrated based on the contact, it is possible to establish a floating window including the integrated message content for the contact and display the floating window corresponding to the contact in the screen locked interface.

It should be appreciated that a size of the floating window is related to the amount of the integrated message contents.

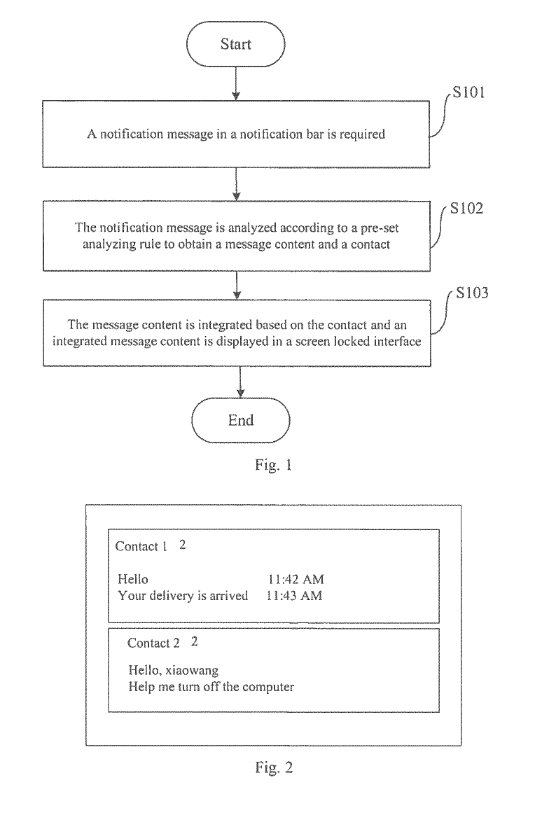

For example, the correspondence between the message content and the contact is as shown in Table 1, it is assumed that the message contents in the correspondence all are sent by wechat, it is possible to integrate the message contents corresponding to the same contact in the correspondence, generate a floating window including the integrated message content, and display the floating window in the screen locked interface of the mobile terminal, so as to facilitate users to check the notification message corresponding to the application in the screen locked interface. Forms of the notification message displayed in the screen locked interface are shown as an example in, but not limited to FIG. 2, which is a schematic diagram showing a part of the screen locked interface including notification messages.

TABLE 1
correspondence between the message content and the contact

| Contact | Message content |
|---|---|
| Contact 1 | Hello |
| Contact 2 | Hello, xiaowang |
| Contact 1 | Your delivery is arrived |
| Contact 2 | Help me turn off the computer |

With the method for displaying the notification message according to embodiments of the present disclosure, the notification message in the notification bar is acquired, the notification message is analyzed according to the pre-set analyzing rule to obtain the message content and the contact, the message content is integrated based on the contact, and the integrated message content is displayed in the screen locked interface, such that the notification message is displayed in the screen locked interface based on the contact, thereby facilitating users to check the message content, and thus improving efficiency of checking the notification message.

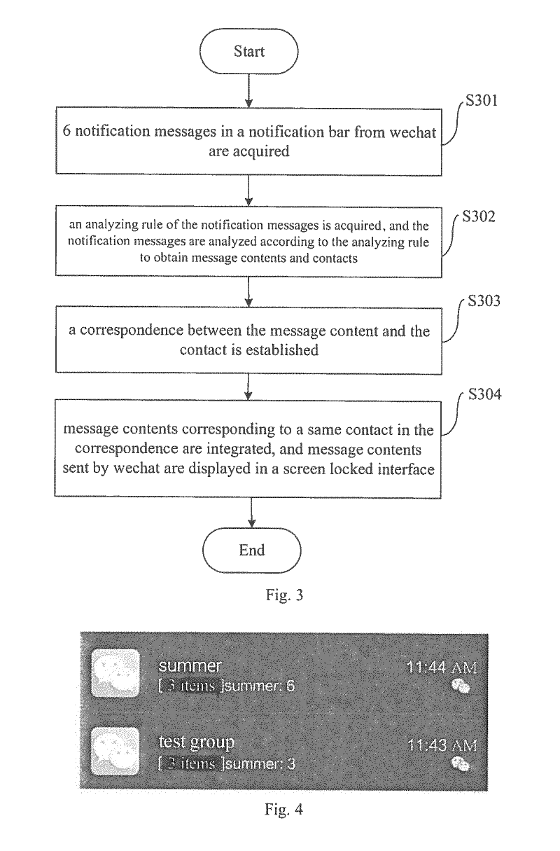

FIG. 3 is a flow chart of a method for displaying a notification message according to another embodiment of the present disclosure. In this embodiment, the method for displaying the notification message is specifically illustrated based on an example where the notification message sent by wechat is analyzed, and the message content is displayed in the screen locked interface of the smartphone. It is assumed that contents of the notification message sent by wechat and displayed in the notification bar are as shown in FIG. 4. It should be noted that, FIG. 4 is only a partial screenshot of the notification bar interface.

S301, 6 notification messages in a notification bar from wechat are acquired.

S302, an analyzing rule of the notification messages is acquired, and the notification messages are analyzed according to the analyzing rule to obtain message contents and contacts.

Specifically, identification information of wechat, such as a package name or a package signature of wechat, is acquired, an analyzing rule for the notification messages sent by wechat and pre-stored in a mobile terminal is acquired based on the identification information of wechat, and then the notification messages are analyzed according the analyzing rule.

As an example to illustrate the specific process for analyzing notification messages, the latest notification message in the notification bar from a contact “summer” is analyzed as follows.

A title of the first notification message in the notification bar is analyzed according to the analyzing rule to obtain a first contact in the title, i.e., it is obtained that the content in the title of the first notification message is “summer”. Afterwards, contents included in a content view of the first notification message are analyzed. Specifically, “[3 items]” is firstly excluded from the contents in the content view, after which a first separation identification information “:” (i.e., colon+space) is acquired from the remaining contents (i.e., “summer: 6”), and the content “summer” at a left side of the first separation identification information is taken as a second contact and the content at a right side of the first separation identification information is taken as a first message content, that is, “6” is taken as the first message content.

Afterwards, it is judged whether the first contact is the same as the second contact. It can be seen from the comparison that, both the first contact and the second contact are “summer”, then it can be determined that the first contact is the same as the second contact, and the current notification message is a private message. In such a case, the first message content is taken as the message content of the notification message.

It should be illustrated that, the analyzing process for the first two notification messages sent by the contact “summer” is similar to that for the latest message content and will not be elaborated herein.

As an example to illustrate the specific process for analyzing group messages, the latest notification message from summer in the “test group” is analyzed as follows.

The second notification message in the notification bar shown in FIG. 4 is analyzed according to the analyzing rule. Specifically, it is possible to analyze a title of the second notification message to obtain a first contact in the title, i.e., it is obtained that the content in the title of the second notification message is “test group”. Afterwards, contents included in a content view of the second notification message are analyzed. Specifically, “[3 items]” is firstly excluded from the contents in the content view, after which a first separation identification information “:” (i.e., colon+space) is acquired from the remaining contents (i.e., “summer: 3”), and the content “summer” at a left side of the first separation identification information is taken as a second contact and the content at a right side of the first separation identification information as a first message content, that is, “3” is taken as the first message content.

Afterwards, it is judged whether the first contact is the same as the second contact. It can be seen from the comparison that, the first contact is not the same as the second contact, then it can be determined that the current notification message is a group message. In such a case, “summer: 3” is taken as the message content of the current notification message.

It should be illustrated that, the analyzing process for the first two notification messages from “summer” in the “test group” is similar to that for the latest message content and will not be elaborated herein.

S303, a correspondence between the message content and the contact is established.

Specifically, it is assumed that message contents of the first two notification messages in the notification bare from “summer” are “4” and “5”, respectively, and that the first two notification messages received under the contact “test group” are also sent by “summer” and the corresponding contents are “1” and “2”, respectively, after analysis to the notification messages in the notification bare, the correspondence between the message content and the contact is established based on analytic results, which is shown in Table 2.

TABLE 2
correspondence between the message content and the contact

| Contact | Message content |
|---|---|
| Summer | 4 |
| Summer | 5 |
| Summer | 6 |
| Test group | Summer: 1 |
| Test group | Summer: 2 |
| Test group | Summer: 3 |

S304, message contents corresponding to a same contact in the correspondence are integrated, and message contents sent by wechat are displayed in a screen locked interface.

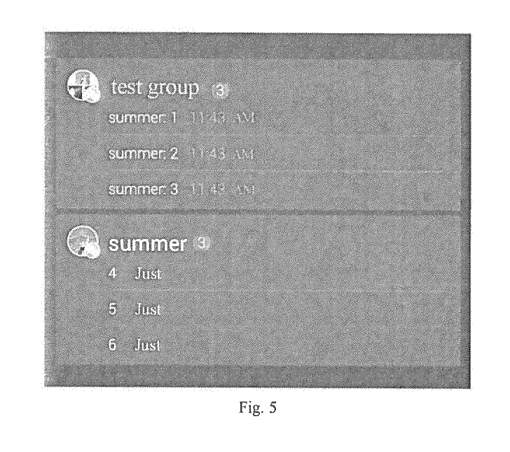

Specifically, the message contents corresponding to the same contact in the correspondence are integrated, a floating window including the integrated message content is generated, and the floating window is displayed in the screen locked interface of a mobile terminal, thereby facilitating users to check the notification message sent by wechat users in the screen locked interface. Forms of wechat messages displayed in the screen locked interface of the mobile terminal are shown in FIG. 5, which only shows a part of the screen locked interface including wechat messages.

With the method for displaying the notification message according to embodiments of the present disclosure, the notification message in the notification bar pushed by wechat is analyzed; the correspondence between the message content and the contact is established; the message contents corresponding to a same contact in the correspondence are integrated; and the integrated message content is displayed in a screen locked interface based on the contacts, such that the notification message is displayed in the screen locked interface based on the contact, thereby facilitating users to check the message content, and thus improving efficiency of checking the notification message.

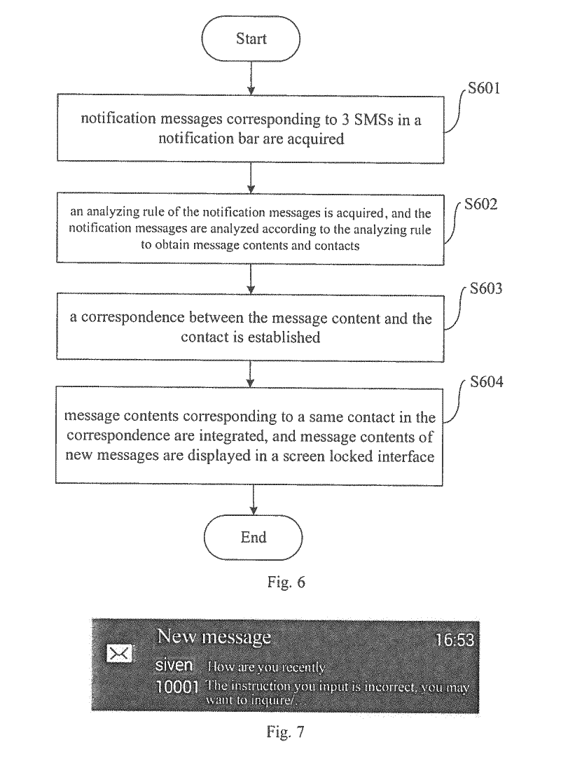

FIG. 6 is a flow chart of a method for displaying a notification message according to yet another embodiment of the present disclosure. This embodiment uses a case where a smartphone receives SMSs as an example to illustrate the specific processes for analyzing the notification messages corresponding to the SMSs displayed in the notification bar and displaying message contents of SMSs in the smartphone. It is assumed that forms of the notification message corresponding to the SMSs displayed in the notification bar are shown as in FIG. 7. It should be noted that, FIG. 7 is only a partial screenshot of the notification bar interface.

S601, notification messages corresponding to 3 SMSs in a notification bar are acquired.

S602, an analyzing rule of the notification messages is acquired, and the notification messages are analyzed according to the analyzing rule to obtain message contents and contacts.

In the following, analyzing the latest notification message sent by a contact “siven” is taken as an example to illustrate a specific process for analyzing notification messages.

Contents of the notification message, “siven:how are you recently”, from the contact “siven” in the notification bar are analyzed according to an analyzing rule of SMS to obtain a second separation identification information “:”, and a content at a left side of the second separation identification information is taken as the contact of the notification message and a content at a right side of the second separation identification information as the content of SMS.

It should be appreciated that, the analyzing process for the notification message in the notification bar from a contact “10001” is similar to that from “siven” and will not be elaborated herein.

S603, a correspondence between the message content and the contact is established.

Specifically, it is assumed that a message content of a former notification message in the notification bare from “siven” is “Hello”, and that a message content of a notification message received from the contact “10001” is “The instruction you input is incorrect, you may want to inquire or conduct the following operations: 328 (SMS transfer), 1 (telephone bill and points) and 112 (electronic bill), 8 (common information query), 412 (Introduction of 4G directional traffic pack), please reply the corresponding instruction”, after analysis to notification messages in the notification bare as shown in FIG. 7, the correspondence between the message content and the contact is established based on analytic results, which is shown in Table 3.

TABLE 3
correspondence between the message content and the contact

| Contact | Message content |
|---|---|
| siven | Hello |
| 10001 | The instruction you input is incorrect, you may |
| | want to inquire or conduct the following |
| | operations: 328 (SMS transfer), 1 (telephone |
| | bill and points) and 112 (electronic bill), 8 |
| | (common information query), 412 |
| | (Introduction of 4G directional traffic pack), |
| | please reply the corresponding instruction. |
| siven | How are you recently |

S604, message contents corresponding to a same contact in the correspondence are integrated, and message contents of new messages are displayed in a screen locked interface.

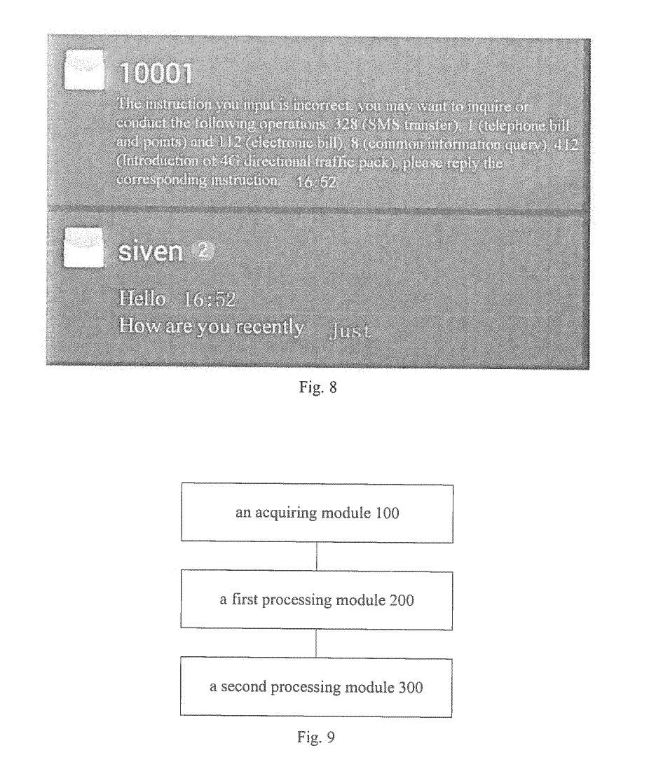

Specifically, the message contents corresponding to the same contact in the correspondence are integrated, a floating window including the integrated message content is generated, and the floating window is displayed in the screen locked interface of a mobile terminal, thereby facilitating users to check contents of new SMSs in the screen locked interface. Forms of SMSs displayed in the screen locked interface of the mobile terminal are shown in FIG. 8.

It should be noted that, the correspondence between the message content and the contact established in the mobile terminal may be deleted after the integrated message content is displayed in the screen locked interface based on the contacts, so as to reduce their occupation in the storage space of the mobile terminal.

With the method for displaying the notification message according to embodiments of the present disclosure, the notification message corresponding to SMS in the notification bar is analyzed; the correspondence between the message content and the contact is established; the message contents corresponding to a same contact in the correspondence are integrated; and the integrated message content is displayed in the screen locked interface based on the contacts, such that the notification message is displayed in the screen locked interface based on the contact, thereby facilitating users to check the message content, and thus improving efficiency of checking the notification message.

In order to realize the above embodiments, the present disclosure further provides a device for displaying a notification message.

FIG. 9 is a block diagram of a device for displaying a notification message according to an embodiment of the present disclosure.

As shown in FIG. 9, the device includes an acquiring module 100, a first processing module 200 and a second processing module 300.

The acquiring module 100 is configured to acquire a notification message in a notification bar. The first processing module 200 is configured to analyze the notification message according to a pre-set analyzing rule to obtain a message content and a contact. The second processing module 300 is configured to integrate the message content based on the contact and display an integrated message content in a screen locked interface.

Specifically, when a mobile terminal is in a screen locked state, the acquiring module 100 may monitor a notification bar management interface of an operating system of the mobile terminal and acquire from the notification bar management interface a notification message received by the notification bar when it is monitored that the notification bar management interface receives the notification message sent by an application.

The application may be an IM application or a SMS application. For example, the application may be the IM application, such as whatsapp, facebook messenger, wechat and the like.

Specifically, the first processing module 200 may determine the application corresponding to the notification message, acquire identification information of the application, and acquire the analyzing rule corresponding to the notification message according to the identification information of the application, after the acquiring module 100 acquires the notification message in the notification bar.

Specifically, after the first processing module 200 acquires the identification information of the application, the first processing module 200 may acquire the analyzing rule corresponding to the notification message according to the identification information of the application and a pre-stored correspondence between the application and the analyzing rule of the notification message.

If the application corresponding to the notification message is an IM application, the first processing module 200 is configured to: analyze a title of the notification message to obtain a first contact in the title; analyze a content of the notification message to obtain first separation identification information in the content of the notification message, take a content at a left side of the first separation identification information as a second contact and a content at a right side of the first separation identification information as a first message content; and judge whether the first contact is the same as the second contact, if yes, determine the notification message to be a private message, and take the first contact as the contact of the notification message and the first message content as the message content of the notification message; if no, determine the notification message to be a group message, take the first contact as the contact of the notification message, and take the second contact and the first message content as the message content of the notification message.

Further, if the application corresponding to the notification message is a SMS application, the first processing module 200 is configured to: analyze a content of the notification message to obtain second separation identification information in the content of the notification message; take a content at a left side of the second separation identification information as the contact of the notification message; and take a content at a right side of the second separation identification information as the message content of the notification message.

The first separation identification information and the second separation identification information as described above each are a character string. For example, if the notification message is sent by wechat, the corresponding first separation identification information may be “:” (i.e., colon+space). Besides, if the notification message is sent by SMS, the corresponding second separation identification information may be “:”, that is, during the analyzing process, a colon is taken as a separator, a content at a left side of the colon is taken as the contact of the notification message, and a content at a right side of the colon is taken as the message content of the notification message.

Specifically, after the message contents and the contacts of the notification message are analyzed by the first processing module 200, the second processing module 300 may establish a correspondence between the message content and the contact and integrate the message contents corresponding to a same contact in the correspondence.

After integrating the message content based on the contact, the second processing module 300 establishes a floating window including the integrated message content for the contact and displays the floating window corresponding to the contact in the screen locked interface.

It should be illustrated that, explanations mentioned above to the embodiments with respect to the method for displaying a notification message are also applicable to embodiments with respect to the device for displaying a notification message and will not be elaborated herein.

With the device for displaying the notification message according to embodiments of the present disclosure, the acquiring module requires the notification messages in the notification bar when the mobile terminal is in the screen locked state; the first processing module requires the analyzing rules of the notification messages, analyzes the notification messages according to the analyzing rules to obtain the message contents and the contacts, and establishes the correspondence between the message content and the contact; and the second processing module integrates the message contents corresponding to a same contact in the correspondence, and displays the integrated message content in the screen locked interface based on the contacts, such that the notification message in the notification bar is analyzed, and the message content of the notification message is displayed in the screen locked interface, thereby allowing users to check the message content of the notification message in the screen locked interface without opening applications, facilitating users to check and handle the notification message, reducing operations of checking the message content and improving efficiency of checking the notification messages.

In order to realize the above embodiments, the present disclosure provides in embodiments a mobile terminal, which includes a shell, a processer, a memory, a circuit board and a power circuit. The circuit board is disposed in a space defined by the shell. The memory is disposed on the circuit board and configured to store an executable program code. The processer is disposed on the circuit board and configured to read the executable program code stored in the memory to execute a program corresponding to the executable program code. The power circuit is configured to supply power to each component or circuit of the mobile terminal. The processer is further configured to execute the following steps.

S101′, a notification message in a notification bar is acquired.

Specifically, when a mobile terminal is in a screen locked state, it is possible to monitor a notification bar management interface of an operating system of the mobile terminal and acquire from the notification bar management interface a notification message received by the notification bar when it is monitored that the notification bar management interface receives the notification message sent by an application.

The application may be an IM application or a SMS application. For example, the application may be the IM application, such as whatsapp, facebook messenger, wechat and the like.

For example, if the mobile terminal is a smartphone based on an android system, it is possible to monitor a Notification Listener Service interface of the smartphone and acquire from the Notification Listener Service interface a notification message sent by an application when the smartphone receives the notification message sent by the application. It should be noted that, the Notification Listener Service is such a service that is activated by the android system, and the android system will send an action and information of a notification back to the Notification Listener Service when an application launches the notification.

S102′, the notification message is analyzed according to a pre-set analyzing rule to obtain a message content and a contact.

Specifically, it is possible to determine the application corresponding to the notification message, acquire identification information of the application, and acquire the analyzing rule corresponding to the notification message according to the identification information of the application, after the notification message in the notification bar is acquired.

Specifically, after the identification information of the application is acquired, it is possible to acquire the analyzing rule corresponding to the notification message according to the identification information of the application and a pre-stored correspondence between the application and the analyzing rule of the notification message.

Further, it is possible to analyze the notification message according to the analyzing rule after determining the analyzing rule corresponding to the notification message.

It should be noted that, the analyzing rules corresponding to notification messages sent by different applications are different.

If a current notification message in the notification bar is a notification message sent by an IM application, it is possible to analyze a title of the notification message first to obtain a first contact in the title, then analyze a content of the notification message to obtain first separation identification information in the content of the notification message, take a content at a left side of the first separation identification information as a second contact and take a content at a right side of the first separation identification information as a first message content, and judge whether the first contact is the same as the second contact, if yes, determine the notification message to be a private message, and take the first contact as the contact of the notification message and the first message content as the message content of the notification message.

In an embodiment of the present disclosure, if the first contact is not the same as the second contact, it is determined that the notification message is a group message, then the first contact is taken as the contact of the notification message, and the second contact and the first message content are taken as the message content of the notification message. Specifically, contents in a content view of the notification bar can be directly as the message content of the notification message.

In an embodiment of the present disclosure, if the notification message in the notification bar is a notification message sent by a SMS application, it is possible, after the analyzing rule of the notification message is determined, to analyze a content of the notification message to obtain second separation identification information in the content of the notification message, and to take a content at a left side of the second separation identification information as the contact of the notification message and to take a content at a right side of the second separation identification information as the message content of the notification message.

In an embodiment of the present disclosure, the first separation identification information and the second separation identification information each are a character string.

For example, if the notification message is sent by wechat, the corresponding first separation identification information may be “:” (i.e., colon+space). Besides, if the notification message is sent by SMS, the corresponding second separation identification information may be “:”, that is, during the analyzing process, a colon is taken as a separator, a content at a left side of the colon is taken as the contact of the notification message, and a content at a right side of the colon is taken as the message content of the notification message.

S103′, the message content is integrated based on the contact and an integrated message content is displayed in a screen locked interface.

Specifically, after the message contents and the contacts of the notification message are analyzed, it is possible to establish a correspondence between the message content and the contact and integrate the message contents corresponding to a same contact in the correspondence.

After the message content is integrated based on the contact, it is possible to establish a floating window including the integrated message content for the contact and display the floating window corresponding to the contact in the screen locked interface.

It should be appreciated that a size of the floating window is related to the amount of the integrated message contents.

For example, the correspondence between the message content and the contact is as shown in Table 1, it is assumed that the message contents in the correspondence all are sent by wechat, it is possible to integrate the message contents corresponding to the same contact in the correspondence, generate a floating window including the integrated message content, and display the floating window in the screen locked interface of the mobile terminal, so as to facilitate users to check the notification message corresponding to the application in the screen locked interface. Forms of the notification message displayed in the screen locked interface are shown as an example in, but not limited to FIG. 2, which is a schematic diagram showing a part of the screen locked interface including notification messages.

TABLE 1
correspondence between the message content and the contact

| Contact | Message content |
|---|---|
| Contact 1 | Hello |
| Contact 2 | Hello, xiaowang |
| Contact 1 | Your delivery has arrived |
| Contact 2 | Help me turn off the computer |

With the mobile terminal according to embodiments of the present disclosure, the notification message in the notification bar is acquired, the notification message is analyzed according to the pre-set analyzing rule to obtain the message content and the contact, the message content is integrated based on the contact, and the integrated message content is displayed in the screen locked interface, such that the notification message is displayed in the screen locked interface based on the contact, thereby facilitating users to check the message content, and thus improving efficiency of checking the notification message.

Reference throughout this specification to “an embodiment”, “some embodiments”, “one embodiment”, “another example”, “an example”, “a specific example” or “some examples” means that a particular feature, structure, material, or characteristic described in connection with the embodiment or example is included in at least one embodiment or example of the present disclosure. Thus, the appearances of the phrases such as “in some embodiments”, “in one embodiment”, “in an embodiment”, “in another example”, “in an example” “in a specific example” or “in some examples” in various places throughout this specification are not necessarily referring to the same embodiment or example of the present disclosure. Furthermore, the particular features, structures, materials, or characteristics may be combined in any suitable manner in one or more embodiments or examples. Moreover, it will be apparent to those skilled in the art that various embodiments or examples, as well as features of different embodiments or examples described throughout this specification, may be combined and combined without contradictory.

In addition, terms such as “first” and “second” are used herein for purposes of description and are not intended to indicate or imply relative importance or significance or to imply the number of indicated technical features. Thus, the feature defined with “first” and “second” may comprise explicitly or implicitly one or more of this feature. In the description of the present disclosure, “a plurality of” means two or more than two, such as two or three, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, in which the order of execution is different from what is shown or discussed, including executing functions in a substantially simultaneous manner or in an opposite order according to the related functions. These and other aspects should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It can be understood that all or part of the steps in the method of the above embodiments can be implemented by instructing related hardware via programs, the program may be stored in a computer readable storage medium, and the program includes one step or combinations of the steps of the method when the program is executed.

In addition, each functional unit in the present disclosure may be integrated in one progressing module, or each functional unit exists as an independent unit, or two or more functional units may be integrated in one module. The integrated module can be embodied in hardware, or software. If the integrated module is embodied in software and sold or used as an independent product, it can be stored in the computer readable storage medium.

The storage medium mentioned above may be read-only memories, magnetic disks, CD, etc. Although explanatory embodiments have been shown and described hereinbefore, it would be appreciated by those skilled in the art that the above embodiments are explanatory and illustrative, cannot be construed to limit the present disclosure, and changes, alternatives, and modifications can be made in the embodiments without departing from spirit, principles and scope of the present disclosure.

What is claimed is:

1. A method for displaying a notification message, comprising:
acquiring a notification message in a notification bar;
analyzing the notification message according to a pre-set analyzing rule to obtain a message content and a contact;
integrating the message content based on the contact; and
displaying an integrated message content in a screen locked interface.

2. The method according to claim 1, wherein integrating the message content based on the contact comprises:
establishing a correspondence between the message content and the contact; and
integrating the message contents corresponding to a same contact in the correspondence.

3. The method according to claim 1, wherein if an application corresponding to the notification message is an instant messaging application, analyzing the notification message according to the pre-set analyzing rule to obtain the message content and the contact comprises:
analyzing a title of the notification message to obtain a first contact in the title;
analyzing a content of the notification message to obtain first separation identification information in the content of the notification message, taking a content at a left side of the first separation identification information as a second contact, and taking a content at a right side of the first separation identification information as a first message content; and
judging whether the first contact is the same as the second contact, if yes, determining the notification message to be a private message, taking the first contact as the contact of the notification message, and taking the first message content as the message content of the notification message; if no, determining the notification message to be a group message, taking the first contact as the contact of the notification message, and taking the second contact and the first message content as the message content of the notification message.

4. The method according to claim 1, wherein if an application corresponding to the notification message is a short message service application, analyzing the notification message according to the pre-set analyzing rule to obtain the message content and the contact comprises:
analyzing a content of the notification message to obtain second separation identification information in the content of the notification message;
taking a content at a left side of the second separation identification information as the contact of the notification message; and
taking a content at a right side of the second separation identification information as the message content of the notification message.

5. The method according to claim 3, wherein the first separation identification information and the second separation identification information each are a character string.

6. The method according to claim 1, wherein displaying the integrated message content in the screen locked interface comprises:
establishing a floating window comprising the integrated message content for the contact, and displaying the floating window corresponding to the contact in the screen locked interface.

7. A mobile terminal, comprising:
a shell;
a circuit board disposed in a space defined by the shell;
a memory, disposed on the circuit board and that stores an executable program code;
a processer, disposed on the circuit board and that reads the executable program code stored in the memory to execute a program corresponding to the executable program code; and
a power circuit, supplying power to each component or circuit of the mobile terminal,
wherein the processer is further configured to:
acquire a notification message in a notification bar;
analyze the notification message according to a pre-set analyzing rule to obtain a message content and a contact;
integrate the message content based on the contact; and
display an integrated message content in a screen locked interface.

8. A computer-readable storage medium, having stored therein instructions that, when executed by a processor of a terminal, causes the terminal to perform a method for displaying a notification message, the method comprising:
acquiring a notification message in a notification bar;
analyzing the notification message according to a pre-set analyzing rule to obtain a message content and a contact;
integrating the message content based on the contact; and
displaying an integrated message content in a screen locked interface.

9. The method according to claim 2, wherein if an application corresponding to the notification message is an instant messaging application, analyzing the notification message according to the pre-set analyzing rule to obtain the message content and the contact comprises:
analyzing a title of the notification message to obtain a first contact in the title;
analyzing a content of the notification message to obtain first separation identification information in the content of the notification message, taking a content at a left side of the first separation identification information as a second contact, and taking a content at a right side of the first separation identification information as a first message content; and
judging whether the first contact is the same as the second contact, if yes, determining the notification message to be a private message, taking the first contact as the contact of the notification message, and taking the first message content as the message content of the notification message; if no, determining the notification message to be a group message, taking the first contact as the contact of the notification message, and taking the second contact and the first message content as the message content of the notification message.

10. The method according to claim 2, wherein if an application corresponding to the notification message is a short message service application, analyzing the notification message according to the pre-set analyzing rule to obtain the message content and the contact comprises:
analyzing a content of the notification message to obtain second separation identification information in the content of the notification message;
taking a content at a left side of the second separation identification information as the contact of the notification message; and
taking a content at a right side of the second separation identification information as the message content of the notification message.

11. The method according to claim 4, wherein the first separation identification information and the second separation identification information each are a character string.

12. The method according to claim 2, wherein displaying the integrated message content in the screen locked interface comprises:
establishing a floating window comprising the integrated message content for the contact, and displaying the floating window corresponding to the contact in the screen locked interface.

13. The method according to claim 3, wherein displaying the integrated message content in the screen locked interface comprises:
establishing a floating window comprising the integrated message content for the contact, and displaying the floating window corresponding to the contact in the screen locked interface.

14. The method according to claim 4, wherein displaying the integrated message content in the screen locked interface comprises:
establishing a floating window comprising the integrated message content for the contact, and displaying the floating window corresponding to the contact in the screen locked interface.

15. The mobile terminal according to claim 7, wherein the processor integrates the message content based on the contact by:
establishing a correspondence between the message content and the contact; and
integrating the message contents corresponding to a same contact in the correspondence.

16. The mobile terminal according to claim 7, wherein if an application corresponding to the notification message is an instant messaging application, the processor analyzes the notification message according to the pre-set analyzing rule to obtain the message content and the contact by:
analyzing a title of the notification message to obtain a first contact in the title;
analyzing a content of the notification message to obtain first separation identification information in the content of the notification message, taking a content at a left side of the first separation identification information as a second contact, and taking a content at a right side of the first separation identification information as a first message content; and
judging whether the first contact is the same as the second contact, if yes, determining the notification message to be a private message, taking the first contact as the contact of the notification message, and taking the first message content as the message content of the notification message; if no, determining the notification message to be a group message, taking the first contact as the contact of the notification message, and taking the second contact and the first message content as the message content of the notification message.

17. The mobile terminal according to claim 7, if an application corresponding to the notification message is a short message service application, the processor analyzes the notification message according to the pre-set analyzing rule to obtain the message content and the contact by:
analyzing a content of the notification message to obtain second separation identification information in the content of the notification message;
taking a content at a left side of the second separation identification information as the contact of the notification message; and
taking a content at a right side of the second separation identification information as the message content of the notification message.

18. The mobile terminal according to claim 16, the first separation identification information and the second separation identification information each are a character string.

19. The mobile terminal according to claim 17, the first separation identification information and the second separation identification information each are a character string.

20. The mobile terminal according to claim 7, wherein the processor displays the integrated message content in the screen locked interface by:
establishing a floating window comprising the integrated message content for the contact, and displaying the floating window corresponding to the contact in the screen locked interface.
